(19) United States
(12) Patent Application Publication
(10) Pub. No.: US 2003/0095500 A1
(43) Pub. Date: May 22, 2003

(54) Methods for distributed shared mesh restoration for optical networks

(75) Inventor: Yang Cao, Chelmsford, MA (US)

Correspondence Address: LAHIVE & COCKFIELD, 28 STATE STREET, BOSTON, MA, 02109, US

(73) Assignee: Sycamore Networks, Inc., Chelmsford, MA

(21) Appl. No.: 10/004,475

(22) Filed: Oct. 23, 2001

(51) Int. Cl. G01R 31/08

(52) U.S. Cl. 370/216; 370/242

(57) ABSTRACT

A method for shared distributed mesh optical network restoration includes defining a set of attributes for the links, which further includes globally disseminated and locally kept attributes. The method further includes finding a SRLG-disjoint diversely routed paths, including allocating resources by updating attributes along the links on the backup path. The fault recovery process is started by first detecting and propagating the fault to the tail end of the faulty path, starting from tail end node, for each node along the faulty path. Recovery information is then passed to an egress port. An OXC is configured, updating reserved resource by modifying the attributes for each involved link. Further fault information is disseminated to the network.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The present invention relates generally to restoration for mesh networks, and more particularly, to distributed shared restoration schemes for optical networks.

### BACKGROUND OF THE INVENTION

Wavelength-division multiplexing (WDM) has been extensively deployed within today's transport networks. The deployment of optical cross-connects (OXCs) which are interconnected via WDM links and optical add/drop multiplexers (OADMs) into these networks will offer promising reconfigurable optical networks, which have the potential to provide on-demand establishment of high-bandwidth connections (e.g., lightpaths).

In the network considered, the physical hardware is deployed but the network connectivity is not defined until lightpaths are established within the network. A lightpath is a constant bit-rate (e.g., OC-48) data stream connected between two network elements such as IP routers. The lightpaths are provisioned by choosing a route through the network with sufficient available capacity. The lightpaths are established by allocating capacity on each link along the chosen route, and appropriately configuring the OXCs.

Because of the enormity of the traffic that optical networks are expected to carry, optical network survivability has become an issue of paramount importance. In conjunction, restoration is provided by reserving capacity on routes that are physically diverse to the primary (working) lightpath. There are many different approaches to providing optical network restoration depending on whether three main functions for backup route: provisioning, link allocation, OXCs configuration are done before (precalculated) or after failure. Three primary categories of methods are: 1) all three functions are done before failure; 2) all three functions are done after failure; 3) provisioning and link allocation are done before failure and OXCs configuration are done after failure. The first method is essentially the 1+1 protection which is fast (in the order of the tens of milliseconds). But since the resource for backup path has to be set aside to ensure that adequate restoration capacity is available upon failure, it is not resource utilization efficient and the reserved resource can not be shared. The second method is a full dynamic restoration approach. The advantages are less preplanning and being dynamic to different failure events, such as multiple link or node failures, the disadvantage is that it is necessarily slower. The third method is a balanced one which uses capacity efficiently and can be fast if implemented appropriately. For the second and third methods, the reserved resource can be shared between multiple restoration paths as long as they do not simultaneously require it.

When there is a failure in a ligthpath, the affected traffic needs to be restored using a backup path. There are two ways in which this restoration may be performed: 1) reroute around the point of failure, e.g., a failure link connection or node; 2) reroute from the end points of the affected traffic. The first method mandates the need for fault localization in advance of initiating restoration actions which can be costly and time-consuming. The second method involves rerouting from the endpoints, and therefore does not require fault isolation. It is expected to be fast because loss of signal can be accurately detected at the end points, from which signaling may be subsequently be initiated to restore the traffic on a backup path, but the implementation has to be careful with regard to provisioning, link allocation, OXCs configuration so that the real-time fault handling is possible. For fast and scaleable optical network restoration, it is also desirable to maintain the network state in a distributed manner as described below.

The flow of data through a mesh optical network is accomplished by transmitting data from one node to the next until the destination is reached. Each node can perform calculations to determine the optimal (such as shortest) path to the destination node based on the global network topology. In link-state routing protocols, the existence of various nodes and connections (or links) in the network are advertised to other nodes in the network. Thus, each router learns the topology of the network. Knowledge of the network topology is used by each node to determine the best path for a particular destination. An example of a link-state routing protocol is the Open Shortest Path First (OSPF) routing protocol. Each node running the OSPF protocol maintains an identical database describing the network topology. If the level of data generated and transmitted through the network in the form of advertisements becomes too large, overall network performance may be reduced. Network nodes may utilize a significant portion of their resources generating, receiving, processing and storing advertisements. It is therefore desirable to provide a system for reducing the amount of node resources used to generate and process network advertisements.

Since the exact location of the fault along the primary path is unknown, the backup path has to be physically-disjoint (diverse) from the primary path. Two fibers are diverse if they are separated by a minimum prescribed distance and do not share a common infrastructure such as a bridge or tunnel. To achieve the network restoration objective, it is necessary to know whether the spans are diverse and the routing of optical links over fiber span. To address this, IETF has proposed the introduction of Shared Risk Link Groups (SRLGs) into routing protocols such as OSPF. The SRLGs describe the set of links that are subject to a single failure, such as a backhoe cutting a fiber conduit.

It would, therefore, be desirable to provide mesh optical networks with a method of feasible SRLG-based distributed shared restoration.

### SUMMARY OF THE INVENTION

The present invention provides methods for distributed shared mesh restoration for an optical network.

In accordance with one aspect of the invention, a set of attributes for the links are defined, wherein the attributes are further categorized into a first subset which will be disseminated to the network in low frequency, a second subset which will be disseminated to the network in high frequency, a third subset which will be kept locally by the end point of the link. The second subset further includes a SRLG attribute.

In accordance with another aspect of the invention, a method of diversely routed paths is provided with a working path and a backup path which is SRLG-disjoint from the working path, which further includes allocating resources by updating attributes along the links on the backup path.

In accordance with still another aspect of the invention, a method of fault recovery further includes starting the restoration process from tail end OXC of the failed path, passing recovery information to the egress port of the OXC and the upstream node of the failed path, configuring the OXC, updating reserved resource by modifying the attributes for each involved link, and disseminating the fault information to the network.

### BRIEF DESCRIPTION OF THE DRAWINGS

The invention will be more fully understood from the following detailed description taken in conjunction with the accompanying drawings, in which:

FIG. 1 is a schematic representation of a mesh optical network.

FIG. 2 is a schematic representation of an interconnection between exemplary source node S and destination node D.

FIG. 3 is a flow diagram illustrating the operation of a path computation & provisioning algorithm.

FIG. 4 is a flow diagram of the restoration process.

FIG. 5 is flow diagram illustrating operation of an exemplary reserved resource update process.

### DETAILED DESCRIPTION OF THE INVENTION

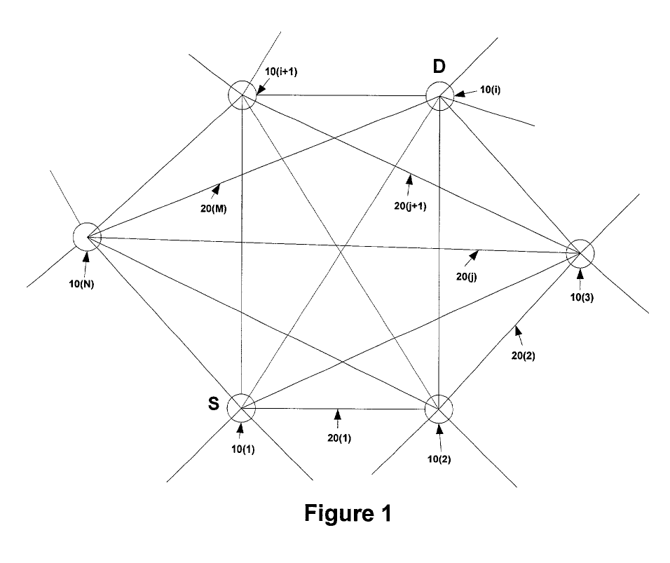

FIG. 1 illustrates a mesh topology optical network which includes a plurality of nodes 10(1), 10(2), . . . 10(N) and a plurality of links 20(1), 20(2), . . . 20(M). Upon request, the nodes calculate the optimal path to a particular destination and forward network traffic. The nodes can be in the form of an Optical add/drop module or an OXC such as SN16000 produced by Sycamore networks, Chelmsford, Mass. The links represent the physical media such as telephone lines, Ethernet cable or fiber-optic cable used to connect the N nodes in the network. For each link such as 20(i), a set of attributes as follows is maintained and periodically disseminated to all of other nodes in the same network:

1. Total bandwidth: TCᵢ

2. Associated SRLG set: Ωᵢ

3. Bandwidth allocated to the active working paths: ACᵢ

4. Bandwidth reserved for the backup paths: BCᵢ

5. SRLG un-weighted set for the backup paths: Ψᵢ

Assume link i is used to protect k paths, and Ψᵢ is defined as the union of the SRLG set associated with each of these k protected paths. In the following description, the term “LSP” will be used to generally refer to either an active or a backup path, which will be clear from the context.

The dissemination of the link attributes can be done via a mechanism like OSPF's Opaque LSA. OSPF routing protocol (OSPF) has been widely deployed throughout the Internet. As a result of this deployment and the evolution of networking technology, OSPF has been extended to support many options. Opaque LSA is an enhancement to the OSPF protocol to support a new class of link-state advertisements (LSA). Opaque LSAs consist of a standard LSA header followed by application-specific information. The information field may be used directly by OSPF or by other applications. Standard OSPF link-state database flooding mechanisms are used to distribute Opaque LSAs to all or some limited portion of the OSPF topology.

Referring back to FIG. 1, to alleviate the burden of node processing LSAs, the attributes of a link 20(i) will be selectively disseminated to other nodes in the network in different manners. For illustration purposes, for the listed exemplary attributes, the first two are static, and the other three may dynamically change during the operation. Given TCᵢ, ACᵢ and BCᵢ, the residual bandwidth associated with link i can be calculated as following: RCᵢ=TCᵢ−ACᵢ−BC_{i.} The static attribute set can be disseminated in low frequency (such as every 2 hours), and the dynamic attribute set can be disseminated in high frequency (like every half hour). Furthermore, optionally, a threshold mechanism can be used here to efficiently control the dissemination overhead.

To reduce the level of data generated and transmitted through the network in the form of advertisements, other than the set of attributes which will be disseminated globally to all of the other nodes, the end point of link 20(i) will also maintain a set of local attributes such as the following local resource utilization information which will not be disseminated to other nodes in the network:

1. SRLG weighted set for the backup paths: Λ_{i. A}ᵢ differs from Ψᵢ in that Λᵢ is the weighted set, and Ψᵢ stands for the corresponding un-weighted set. For example, Λᵢ could be {4α, 3β, 2χ}, the corresponding Ψᵢ would be {α, β, χ} Here α, β, and χ represent shared risk. Later, f represents the functional mapping from the weighted set to the corresponding un-weighted set, or Ψᵢ=f(Λᵢ)

2. Resource reservation table: each entry of this table includes the following: Resource ID (such as time slot ID, wave-length ID), the LSPs (LSP IDs) reserving this specific resource.

3. Backup LSP table: each entry of this table includes the following set of items: LSP ID, source node ID, bandwidth reserved, incoming port ID and outgoing port ID, LSP reservation state: {Normal or Abnormal}. The default LSP reservation state is Normal.

After the link representation & dissemination mechanism is defined as above, the restoration mechanism according to the present invention will be described in the sequence of path computation, provisioning, restoration and resource update using the illustrated embodiment.

Path Computation & Provisioning

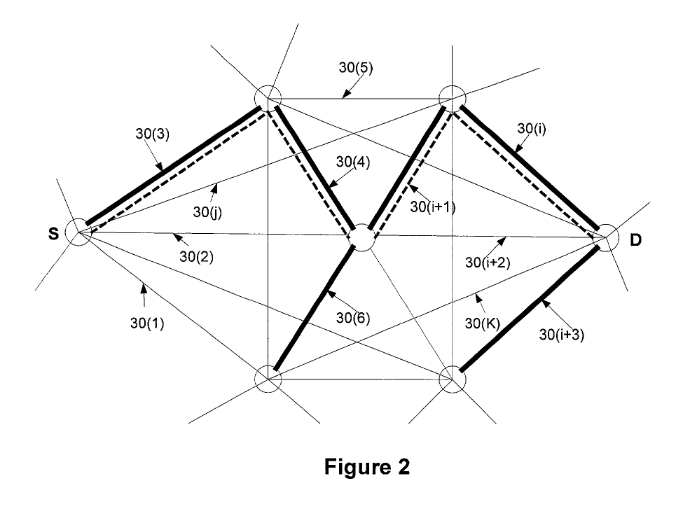

Referring back to FIG. 1 with a pair of exemplary source node S and destination node D, assuming node S receives the request to establish a path with bandwidth β between node S and node D which will also be protected. The protection requires that the active path and the protected path should share no common risk—SRLG disjoint. FIG. 2 discloses further details of the interconnection between node S and node D which includes K links 30(1), 30(2), . . . , 30(i), 30(i+1), 30(i+2), . . . . 30(K). The path computation algorithm can be expressed as follows.

Step 1:

Filtering out the links with RCᵢ less than β. After filtering, the remaining L links are highlighted in black in FIG. 2 as 30(3), 30(4), 30(6), . . . 30(i+1), . . . 30(i+3), . . . 30(L).

Step 2:

Finding the optimal path based on a plurality of criteria such as the minimal cost, or by considering the risks associated with each link in the remaining graph. For the remaining L links involved as in FIG. 2, assuming the obtained optimal path has k links such as 30(3), 30(4), 30(i+1), 30(i) as indicated as dotted line in FIG. 2. The shared risk set Π associated with this path is defined as the union of Ωᵢ associated with each of these k links.

Step 3: Node S signals downstream to set up the active path. If the node downstream can accept this request, it will adjust the corresponding link i's ACᵢ as following: ACᵢ=ACᵢ+β. Otherwise, it will generate negative feedback back to the node S.

If node S receives a positive acknowledgement from the downstream node, node S moves the next step. Otherwise, node S checks whether node S has exceeded the retry limits. If not, filter the problematic link/node, go to Step 1. Otherwise, generate a report that no path is available.

Step 4: Filtering all the links i if the following is true: Π∩Ωᵢ≠Φ to ensure the backup path and the active working path share no common risk.

Step 5:

In the remaining graph, compute the link cost for each link i based on the following logic:

if ( Π ∩ Ψᵢ == Φ )

if (β ≦ BC₁)

cost₁ = 0

else if ((β − BC₁) ≦ RC₁)

cost₁ = β − BCᵢ

else

cost₁ = ∞

else

if (β ≦ RC₁)

costᵢ = β

else

costᵢ = ∞

Step 6:

After assigning the cost as calculated above to each link, compute the minimal cost path as the backup path. If no path is available, it checks whether it has exceeded the retry limits. If not, it filters all links with cost: ∞, go to Step 1.

Step 7: Signal downstream to reserve the backup path. If the node downstream accepts this request (the corresponding link i's RCᵢ exceeds the cost required), it will adjust the corresponding link i's attributes as following:

if ( Π ∩ Ψ₁ == Φ )

if ((β > BCᵢ) && (β − BCᵢ) ≦ RC₁))

BC₁ = β

else

if (β ≦ RCᵢ)

BC₁ = BC₁ + β

Ψ₁ = Π ∪ Ψ₁

The local resource will also be updated correspondingly as the following:

ΛᵢΠ+Λᵢ

Reserve (or virtually assign) the resource to this LSP. Note that the same resource may be virtually assigned to more than one LSP. Record the resource reservation information in the local resource table. Finally record the corresponding LSP information in the LSP table. Note that the tail end of the backup path should note that it's the path's end point.

If the node downstream can't accept this request, the node downstream will generate negative feedback back to the node S.

Step 8: If node S receives the positive acknowledgement from the downstream node, node S completes the path computation and provisioning process. It generates positive report and starts to send traffic over the active path. Otherwise, it checks whether it has exceeded the retry limits. If not, it filters all links with cost: ∞, go to Step 1.

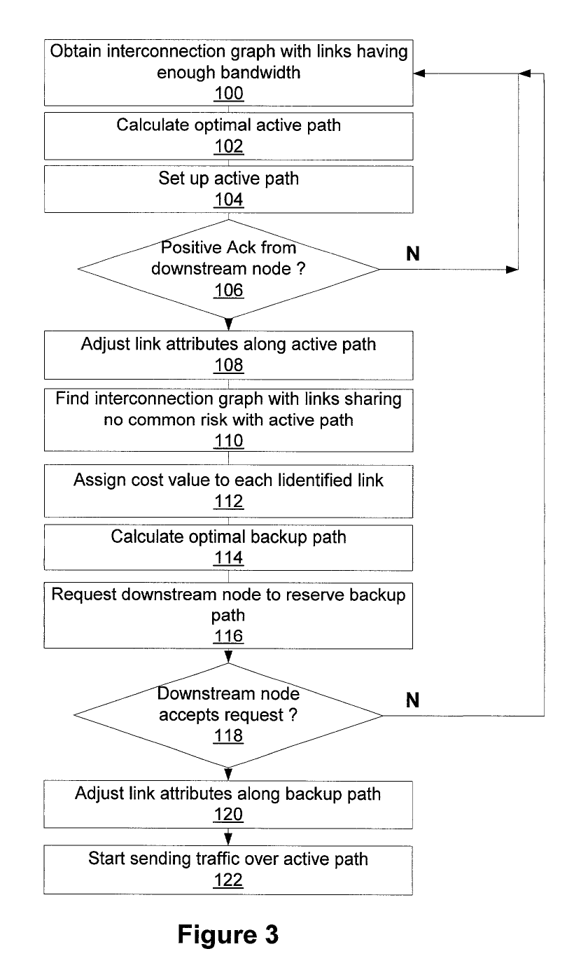

FIG. 3 illustrates the operation of the path computation & provisioning algorithm in accordance with the invention, which calculates an active and a protection path between node S and node D with bandwidth β. First, the interconnection between S and D is obtained by removing links without enough bandwidth (100). The optimal active path is calculated based on a predetermined criteria which can be minimal cost, or minimal risk using a algorithm such as Dijkstra's algorithm (102). The node S will then signal downstream nodes to set up the active path (104). Depending on whether the acknowledgement from the downstream node (106), the algorithm either goes back to 100 when the acknowledgement is negative or adjusts attributes for the links along the active path (108). Next the interconnection between S and D with links sharing no common risk with active path is calculated (110). A cost value for each identified link in 110 is assigned (112). The optimal backup path with minimal cost as assigned in 112 is calculated based on the interconnection from 110 (114). The resource on the backup path is then reserved (116). Depending on whether the downstream node accepts the reservation request (118), the algorithm either goes back to 100 after filtering all links with cost ∞ when downstream node rejects the request, or adjusts attributes for the links along the backup path (120). Last, the traffic can be sent over the active path (122).

Restoration

After a fault happens in one of the active paths in the network, the fault will be detected and identified by the downstream node, via mechanism such as SONET/SDH LOS, LOF etc., which can be done within sub-milli-second. The fault information will be propagated to the tail end OXC of the active path via a mechanism such as SONET/SDH AIS, which can be done in a sub-milli-second per hop way. After the tail end OXC receives the fault information, the tail end OXC will start the recovery process. The tail end OXC will first identify the reserved bandwidth, propagate the recovery information via a mechanism using overhead byte like SONET/SDH's overhead bytes, which includes the LSP ID (assuming in general case, 4 bytes). It passes such information to the egress port via a mechanism like the internal inter-card communication. Then the tail node passes such information to the upstream node. Meanwhile it starts setting up the cross-connect.

Each node upstream will repeat the same process: find out the egress port via the received LSP ID, pass received information via the inter-card communication mechanism, then the upstream node propagates the recovery information upstream until the source node such as node S as in FIG. 2, meanwhile it starts setting up the cross-connect.

To demonstrate how these stages construct the critical stage of real-time fault handling, the performance can be analyzed as follows based on the exemplary embodiments. Based on current art, the first fault detection stage takes 0.375 ms if fault identification is based on mechanisms like LOS, LOP etc., and the second fault propagation stage latency depends on the number of hops between the fault identifying node and the tail end node. Assuming k nodes in between, the second stage will take 0.375*k ms. The key factor of the third fault recovery stage includes:

Number of hops involved in the backup path: m

Ingress port processing latency estimate: 0.5 ms

Egress port processing latency estimate: 0.5 ms

Inter-card communication estimate: 0.5 ms

Cross-connect latency: 5 ms

The third stage latency would be: 1.5*(m−1)+1.0+5=1.5*(m−1)+6 So the total restoration latency would be: 0.375*(k+1)+1.5*(m−1)+6 In most of the cases, k and m would be less than 10, so with the proposed mechanism, the restoration can be finished well within 50 ms.

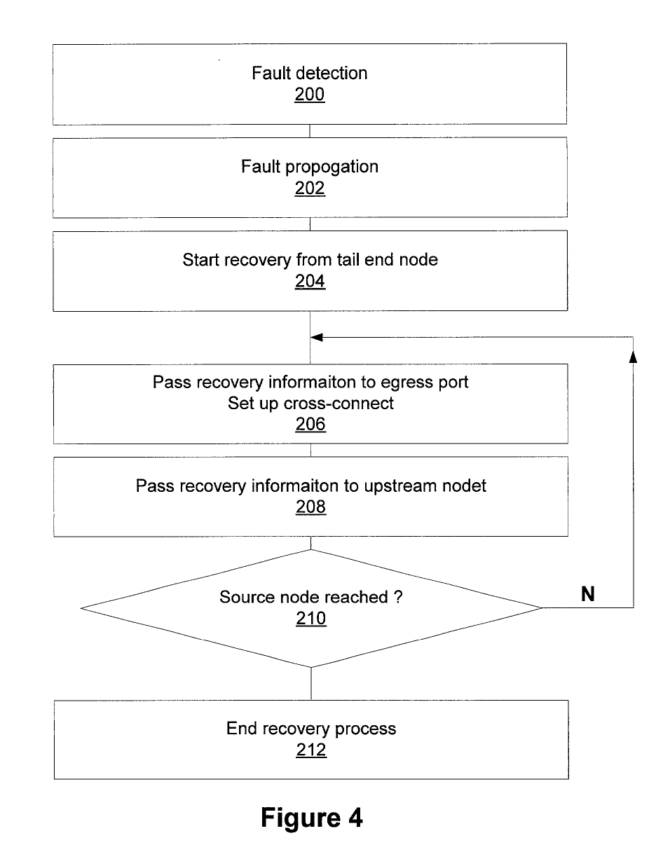

FIG. 4 shows a flow diagram of the restoration process. The fault is first detected (200) and propagated (202). The restoration process will start from tail end OXC node (204). For each involved node, the process includes passing recovery information such as LSP ID to OXC egress port, setting up the cross-connect (206). The same information will then be passed to upstream node (208). Depending on whether the upstream node is the source node of the faulty path (210), the restoration process will continue by going back to 206 or finish (212).

Resource Update

After fault recovery, the resources for the involved links should be updated by adjusting the attributes of the involved links. The resource update processing is not directly contributing to the fault restoration latency.

Reserved Resource Update:

During the restoration stage, the active path with fault will activate its reserved backup path. For each node along the backup path, attributes of the links along the backup path should be updated as follows.

Assuming the SRLG associated with the active path is Π, the required bandwidth is β. The global attributes updates can be done for each involved link i as:

ACᵢ=Aᵢ+β

BCᵢ=BCᵢ−β

Λᵢ=Λᵢ−Π

Ψᵢ=f(Λᵢ)

The local attributes update like the resource reservation table can be done by first examining to see if the allocated bandwidth was only reserved by the faulty active path, if yes, all it needs to do is to delete its corresponding resource reservation table and the backup path table entry, and to establish backup resource via local resource. If the allocated bandwidth was reserved by more than one active path, for each of those paths which lost the original reserved bandwidth, it will try to make further bandwidth reservation based on the following mechanism:

Λᵢ = Λᵢ − Π
Ψᵢ = ƒ(Λᵢ)
if ( Π ∩ Ψ₁ == Φ )

if (β ≦ BC₁)

reserve

else if ((β − BCᵢ) ≦ RCᵢ)

BCᵢ = β, reserve

else

stop

else

if (β ≦ RC₁)

BC₁ = β, reserve

else

stop

In case of “reserve”, the reserved resource table and the backup LSP table needs to be updated correspondingly, Λᵢ is updated as Λᵢ+Π, and Ψᵢ correspondingly is updated as f(Λᵢ).

In case of “stop”, or when the faulty path can't locally book bandwidth on the corresponding link, it will change the corresponding backup LSP's state into Abnormal, then signal the corresponding LSP's source node. Once the LSP's source node receives such signal, the LSP source node is going to release the original backup path, and try to establish another backup path via disclosed Path computation & provisioning algorithm.

The backup path can be released via the following mechanism: during the backup path release process, the source node sends the release request down stream. Each node involved in the backup path will do the following:

If the corresponding backup LSP's state is Normal:

Release the corresponding bandwidth, update the resource reservation table. Assuming the bandwidth released is β′, because of the sharing, β′ could be less than β, sometimes it could be 0:

BCᵢ=BCᵢ−β′

Λᵢ=Λᵢ−Π

Ψᵢ=f(Λᵢ)

Forward the release signaling downsteam, delete the corresponding backup LSP table entry

If the corresponding backup LSP's state is Abnormal:

Forward the release signaling, delete the corresponding resource reservation table and backup LSP table entry

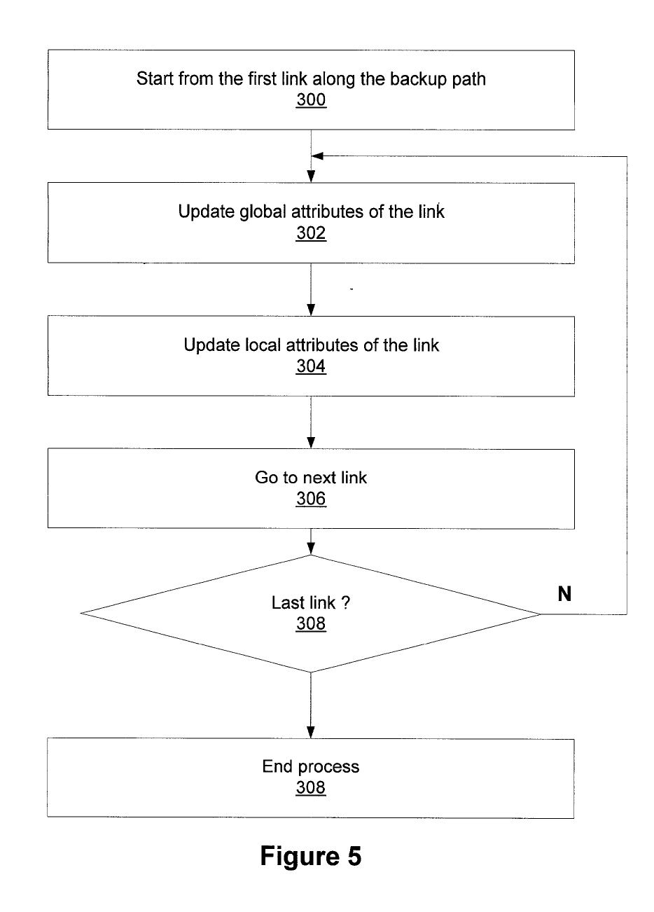

FIG. 5 shows a flow diagram illustrating operation of the exemplary reserved resource update process. Starting from the first link along the backup path (300), for each link, the global attributes are updated first (302), then the local attributes are updated (304), which further includes examining if the allocated bandwidth was reserved by solely the faulty path, and acting accordingly. Then the process will go to next link (306). Depending on whether the last link is reached (308), the process will either continue by going back to 302 or end (308).

Link Fault Update

Via OSPF link state advertisement, the link fault information will be disseminated to each node in the network. Each node is going to determine whether the fault has impact on its active working path or backup path. If the working path is affected, it will send a release signal downstream, and each involved link's ACᵢ is updated as ACᵢ−β; if the backup path is affected, it will go through the backup path deletion process as described above, meanwhile establishing another backup path based on the mechanism as described above.

Although the present invention is described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention. Accordingly, it is submitted that the invention should not be limited by the described embodiments but rather should encompass the spirit and full scope of the appended claims.

What is claimed is:

1. A method for mesh restoration for an optical network with a plurality of nodes and a plurality of links, comprising steps of:
defining a set of attributes for said links;
calculating a backup path for each working path between a first node and a second node in said network, wherein said backup path is SRLG-disjoint from said working path;
activating a backup path for a working path in response to a fault along said working path;
adjusting said attributes for the links along said backup path;
disseminating fault information to said nodes in said optical network.

2. The method according to claim 1 wherein said attributes include attributes which will be disseminated globally to all said nodes in the network.

3. The method according to claim 1 further comprising another set of attributes which will be kept locally by one of the end points of said link.

4. The method according to claim 1 wherein said step of disseminating fault information is via OSPF.

5. The method according to claim 2, wherein said set of attributes further includes a first subset of attributes which will be disseminated in low frequency.

6. The method according to claim 2, wherein said set of attributes further includes a first subset of attributes which will be disseminated in high frequency.

7. The method of claim 5, wherein the subset of attributes includes total bandwidth.

8. The method of claim 5, wherein the subset of attributes includes SRLG-Shared Risk Link Group which is defined as a set of links sharing a common physical resource.

9. The method of claim 6, wherein the subset of attributes includes bandwidth allocated to the working path.

10. The method of claim 6, wherein the subset of attributes includes bandwidth reserved to the backup path.

11. The method of claim 6, wherein the subset of attributes includes weighted SRLG.

12. The method of claim 3, wherein the set of attributes includes a resource reservation table wherein each entry further including a resource ID and paths reserving said resource.

13. The method of claim 12, wherein the resource ID is time slot ID.

14. The method of claim 12, wherein the resource ID is wavelength ID.

15. The method of claim 12, wherein the paths include both working path and backup path.

16. A method for determining diversely routed paths for a mesh optical network with a plurality of nodes and a plurality of links with a plurality of attributes, comprising steps of:
identifying a first node and a second node in response to a request for establishing a path with a required bandwidth between said first and said second node;
finding a first set of links by deleting from the interconnection graph links with a first of said attributes less than said required bandwidth;
finding a first optimal path between said first and second node from said first set of links;
finding a second set of links by further deleting from the interconnection graph the links sharing a second of said attributes with any one of the links along said first optimal path;
assigning a value to said second set of links;
finding a second optimal path between said first and said second node from said second set of links based on said assigned value;
adjusting said first and second attributes for each link along said second optimal path.

17. The method according to claim 16 wherein said first optimal path is the working path.

18. The method according to claim 16 wherein said first optimal path is the backup path.

19. The method according to claim 16 wherein said first attribute is residual bandwidth which is defined as total bandwidth of a link minus bandwidth allocated for working paths and backup paths.

20. The method according to claim 16 wherein said second attribute is SRLG.

21. A method for fault recovery for a mesh optical network with a plurality of OXC nodes, comprising steps of:
detecting the fault in a working path;
starting recovery process from tail end OXC of said path, which further includes:
identifying reserved resource;
passing fault information to the egress port of said OXC;
passing said fault information to upstream node;
configuring said OXC;

22. The method according to claim 21 wherein said step of detecting the fault is via SONET/SDH signal failure.

23. The method according to claim 21 wherein said fault information is propagated via SONET/SDH overhead bytes.

24. The method according to claim 21 wherein said fault information includes a path ID.

25. The method according to claim 21 wherein said step of passing fault information to the egress port is via an inter-card communication mechanism.
